(19) United States
(12) Patent Application Publication
(10) Pub. No.: US 2001/0049421 A1
(43) Pub. Date: Dec. 6, 2001

(54) Thermoset/thermoplastic fibers and process for producing the same

(76) Inventors: Dominick A. Burlone, Arden, NC (US); Doris Carolyn Morgan, Asheville, NC (US)

Correspondence Address: Nixon & Vanderhye P.C., 8th Floor, 1100 N. Glebe Rd., Arlington, VA, 22201, US

(21) Appl. No.: 09/750,773

(22) Filed: Jan. 2, 2001

Related U.S. Application Data
(62) Division of application No. 09/408,194, filed on Sep. 29, 1999.

(51) Int. Cl. C08L 61/20; C08L 61/04; C08L 61/26; C08L 77/00; C08L 61/00

(52) U.S. Cl. 525/427; 525/428; 525/429; 525/480; 525/497; 525/509

(57) ABSTRACT

The present invention modifies a cross-linkable thermoset polymer with a thermoplastic polymer to create a spinnable thermoset/thermoplastic polymer composition that may be spun into thermoset/thermoplastic fibers.

### FIELD OF THE INVENTION

The present invention relates generally to a spinnable polymer composition comprising a cross-linkable thermoset polymer and a thermoplastic polymer and to fibers made from the spinnable polymer composition. The present invention also relates to a method of making a polymer composition comprising a cross-linkable thermoset polymer and a thermoplastic polymer that is spinnable when cured and dried.

### BACKGROUND OF THE INVENTION

Thermoplastic fibers are commonly made using linear, high molecular weight, thermoplastic polymers such as, for example, polyamides, polyesters, and polyolefins. Thermoplastic polymers typically form semi-crystalline fibers that are strong, heat-settable, and dyeable and that have good tensile and optical properties and elongation, in addition to other desirable properties. The fibers formed from these polymers, however, are not flame resistant and tend to melt and drip when exposed to a heat source such as a flame.

Melamine and formaldehyde can be polymerized into a thermoset resin polymer. For example, melamine, formaldehyde, and lesser amounts of additional comonomers are combined, and this relatively low molecular weight resin is cured and crosslinked into a hard resin. The resulting melamine-formaldehyde resin may then be spun into fibers. The resulting fibers are nonflammable and heat and flame resistant. They do not tend to melt and drip when exposed to a heat source. The structure of the melamine-formaldehyde fibers, however, differs in many respects from common thermoplastic fibers, and melamine-formaldehyde fibers lack some of the desirable properties associated with thermoplastic fibers. For example, melamine-formaldehyde fibers tend to be hard and brittle and not heat-settable. Such undesirable characteristics in the melamine-formaldehyde fibers may be improved through the use of substituted-melamine comonomers; however, the fibers may still be weaker and more brittle than desired. Furthermore, melamine-formaldehyde fibers tend to be difficult to handle in the uncured state and bright and difficult to dye when cured.

A need, therefore, exists for a polymer composition that may be spun into fibers wherein the fibers have the desirable characteristics of thermoplastic fibers while retaining the nonflammability and heat and flame resistant properties of fibers made from thermoset polymers such as melamine-formaldehyde resins.

### SUMMARY OF THE INVENTION

It is an object of the present invention to improve the properties of melamine fibers, while retaining nonflammability and flame and heat resistant properties.

Another object of the invention is to provide a spinnable polymer comprising a cross-linkable thermoset polymer and a thermoplastic polymer, the composition of which can be selected to optimize the thermoset properties, as well as the fiber properties, when the polymer is spun into fibers.

It has now been found that these objects are achieved by modifying a cross-linkable thermoset polymer with a thermoplastic polymer.

The above and other objects, effects, features, and advantages of the present invention will become more apparent from the following detailed description of the preferred embodiments thereof.

### DETAILED DESCRIPTION OF THE PREFERRED EMBODIMENTS

To promote an understanding of the principles of the present invention, descriptions of specific embodiments of the invention follow, and specific language is used to describe the same. It will nevertheless be understood that no limitation of the scope of the invention is intended by the use of this specific language and that alterations, modifications, equivalents, and further applications of the principles of the invention discussed are contemplated as would normally occur to one of ordinary skill in the art to which the invention pertains.

The phrase “thermoset/thermoplastic” is used herein to describe a spinnable polymer composition comprising a cross-linkable thermoset polymer and a thermoplastic polymer or a fiber spun from such polymer composition.

According to one embodiment of the present invention, there is provided a thermoset/thermoplastic fiber comprising a blend of a thermoset polymer and a thermoplastic polymer.

In a second embodiment of the present invention there is provided a process for producing a thermoset/thermoplastic fiber comprising a cross-linkable thermoset polymer and a thermoplastic polymer using the steps of providing a suitable thermoset polymer; providing a suitable thermoplastic polymer; blending the thermoset polymer with the thermoplastic polymer to form a thermoset/thermoplastic polymer composition; and spinning thermoset/thermoplastic fibers from the polymer composition.

While various thermosetting polymers are suitable for use in the present invention, melamine-formaldehyde is preferred.

Melamine fibers are notable for their high temperature resistance and nonflammability. Their preparation and properties are known, for example, from DE-A-2364091, which is incorporated herein by reference.

Any melamine resin may be used in the present invention. Suitable melamine resins include, for example, the condensation products of melamine or melamine derivatives with formaldehyde as described in, for example, U.S. Pat. No. 5,084,488 to Weiser et al. and U.S. Pat. No. 5,162,487 to Weiser et al, both of which are incorporated herein by reference.

A preferred melamine resin is obtained when up to about 30 mole percent, and preferably from about 2 mole percent to about 20 mole percent, of the melamine in the melamine resin is replaced by hydroxyalkylmelamine, as described in U.S. Pat. No. 5,322,915 to Weiser et al., the entirety of which is incorporated by reference herein.

Furthermore, minor amounts of melamine may be replaced by ureas, phenols, and substituted melamines.

Particular preference is given to condensation products obtainable by condensation of a mixture comprising, as chief components:

(A) from about 90 to about 99.9 mole percent of a mixture consisting essentially of:

(1) from about 30 to about 99, preferably from about 50 to about 99 and more preferably from about 85 to about 95, mole percent of melamine, and

(2) from about 1 to about 70, preferably from about 1 to about 50 and more preferably from about 5 to about 15, mole percent of a substituted melamine of the general formula I

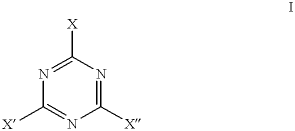

where X, X′ and X″ are each selected from the group consisting of —NH₂, —NHR, and —NRR′ and X, X′ and X″ are not all —NH₂, and R and R′ are each selected from the group consisting of hydroxy-C₂-C₁₀-alkyl, hydroxy-C₂-C₄-alkyl-(oxa-C₂-C₄-alkyl)ₙ, where n is a number from 1 to 5, and amino-C₂-C₁₂-alkyl, or mixtures of melamine I, and

(B) from about 0.1 to about 10, preferably from about 1 to about 5, mole percent, based on (A) and (B), of phenols that are unsubstituted or that are substituted by radicals selected from the group consisting of C₁-C₉-alkyl and hydroxyl, C₁-C₄-alkanes substituted by two or three phenol groups, di(hydroxyphenyl) sulfones, or mixtures of these phenols,

with formaldehyde or formaldehyde-source compounds in a molar ratio of melamine to formaldehyde within the range of from about 1:1.15 to about 1:4.5, and, more preferably, from about 1:1.8 to about 1:3.0.

Formaldehyde is usually used in the form of an aqueous solution having a concentration of, for example, from about 40 to about 50 percent strength by weight aqueous solution or in the form of a compound that liberates formaldehyde during the reaction with (A) and (B) such as, for example, oligomeric or polymeric formaldehyde in solid form, e.g., paraformaldehyde, trioxane, or tetraoxane.

The melamine resins may be manufactured by polycondensing melamine, substituted melamine, and phenol together with formaldehyde or a formaldehyde-liberating compound. The reaction can be started with a mixture of all of the necessary components or, alternatively, the components may be brought together portionwise and successively for conversion to precondensates, to which further amounts of melamine, substituted melamine, and phenol can be added.

Preferably, the resins are produced using melamine-formaldehyde precondensate solutions as described in U.S. Pat. No. 4,996,289 to Berbner et al., which is incorporated herein by reference.

The polycondensation can be carried out at temperatures ranging from about 20° C. to about 150° C. and, more preferably, from about 40° C. to about 140° C.

The pressure at which the reaction is carried out is generally not usually critical, but the pressure used is generally between about 100 and about 500 kPa and is preferably from about 100 to about 300 kPa.

The reaction may be carried out with or without the use of a solvent. When an aqueous formaldehyde solution is used, it will not be necessary to add further solvent. When the formaldehyde is bound in a solid substance, it will be usual to use water as a solvent. The amount of solvent, e.g., water, used is in the range of about 5 to 40 percent w/w and preferably from about 15 to about 24 w/w, based on the total weight of monomers used.

The polycondensation is generally carried out at a pH greater than about 7.0, the preferred range being from about 7.5 to about 10.0 and, particularly, from about 8.0 to about 10.0.

In addition, small amounts of conventional additives may be added to the reaction mixture. Such additive include, for example, alkali metal sulfites, e.g., sodium sulfite and sodium disulfite; alkali metal formates, e.g. sodium formate; alkali metal citrates, e.g., sodium citrate; phosphates, polyphosphates, urea, dicyandiamide, and cyanamide. Such additives may be added individually or in the form of additive mixtures, either in solid form or in the form of aqueous solutions prior to, during, or after the condensation reaction.

Other modifiers that may be used are amines and aminoalcohols such as diethylamine, ethanolamine, diethanolamine, and 2-diethlyaminoethanol.

The polycondensation can be carried out batchwise or continuously in, for example, an extruder, as described in U.S. Pat. No. 4,996,289 to Berbner et al., according to conventional methods.

The thermoplastic polymers used in the present invention may be any linear thermoplastic polymer that is soluble in the thermoset polymer. Preferably, the thermoplastic polymer is water-soluble. Water-soluble thermoplastics useful in the present invention include, but are not limited to, polyamides with solubilizing substituents and copolymers thereof, polyesters with solubilizing substituents and copolymers thereof, polyolefins with solubilizing substituents and copolymers thereof, and cellulose polymers with solubilizing substituents and copolymers thereof.

Suitable water-soluble polyamide polymers include, for example, those polymers obtained from polymerization of conventional polyamide comonomers (e.g. amino acids such as epsilon-caprolactam, diamines such as hexamethyldiamine, and diacids such as adipic or isophthalic acids) and a solubilizing comonomer (e.g., sodium salt of 5-sulfoisophthalic acid or another salt of sulfonated isophthalic acid). Suitable water-soluble polyester polymers include, for example, those polymers obtained by polymerizing polyester comonomers (e.g., terephthalic acid and ethylene glycol) and a solubilizing comonomer (e.g., sodium salt of 5-sulfoisophthalic acid or another salt of sulfonated isophthalic acid). Nonlimiting examples of polyolefin polymers include polyvinyl alcohol, polyvinylpyrrolidone, polyvinyl acetate, polycarboxylic acid, and polyacrylamide. Cellulose polymers according to the invention include, for example, carboxymethylcellulose.

Particular preference is given to the water-soluble polyamide described in U.S. Pat. No. 3,846,507 to Thomm et al., the entirety of which is incorporated herein by reference; the water-soluble copolymer of polyvinylpyrrolidone and vinyl acetate; water-soluble polyvinyl alcohol; water-soluble polyethylene oxide; water-soluble polyvinylpyrrolidone; and the water-soluble polyester polymers described in U.S. Pat. No. 4,098,741 to Login, the entirety of which is incorporated herein by reference.

The thermoplastic polymer is used in an amount ranging from about 0.1 percent by weight to about 20 percent by weight, based on the weight of the thermoset/thermoplastic resin. Preferably, the thermoplastic content is less than about 10 percent by weight and, more preferably, is about 5 percent by weight.

The thermoplastic polymer is added to the thermoset polymer to make a spinnable thermoset/thermoplastic polymer composition. This polymer composition is then spun into fibers.

The fibers may be produced according to any method for making fibers. Preferably, the thermoset/thermoplastic polymer is converted to fibers using a dry spinning process. In a typical dry spinning process, fiber-forming polymer dissolved in solvent is extruded through capillaries into an environment favorable to solvent removal. Preferably, the solvent is water, and the environment is a closed spinning tower with dry recirculated air at nearly room temperature where water is removed at a rate high enough to form as rapidly as possible a fiber with mechanical integrity and low tack, but not so rapidly so as to disrupt the fiber structure, form excessive voids, or cause breakage.

Particular preference is given to a process for producing fibers by spinning the thermoset/thermoplastic polymer composition by a centrifugal spinning process where the spinnerettes are rotating rapidly. This process comprises supplying the thermoset/thermoplastic polymer solution to a whirler plate and ensuring that inside the whirler plate the polymer solution is under a sufficient pressure to completely fill the nozzles of the whirler plate as the fibers are being spun. This process is described in U.S. Pat. No. 5,494,616 to Voelker et al., the entirety of which is incorporated herein by reference. Unlike conventional spinning, there is no pump applying pressure to the resin reservoir above the capillary. Instead, the pressure head is generated by the centrifugal forces acting on the column of resin above and through the capillary. A pump is used merely to deliver the resin to the center of the rotating spinnerette and not to force the resin through the capillary.

After the fiber exits the spin tower, it is then subjected to heat, preferably in a tempering tunnel, at temperatures ranging from about 180° C. to about 220° C. for a time sufficient to cure the fiber and make it more durable. The curing promotes the final crosslinking of the fiber and removes residual water and formaldehyde.

The thermoset/thermoplastic polymer composition of the present invention may be optimized to the desired viscosity and spinnability for the chosen spinning conditions such as, for example, temperature, throughput, capillary dimensions, etc., or for the desired fiber properties such as, for example, luster, flammability, cured and uncured properties, dyeability, etc.

The invention will be further described by reference to the following detailed examples. The examples are set forth by way of illustration and are not intended to limit the scope of the invention. In the examples, the test procedures described below were used.

Denier

The denier of the fiber is determined using a Vibromat tester according to ASTM D1577-79.

Elongation and Tenacity

The elongation and tenacity of the fiber is determined using ASTM D2256-97.

### EXAMPLE 1

### Comparative

A dry powder is formed by mixing together about 465.0 grams of melamine from Melamine Chemical, Inc., about 125.9 grams of paraformaldehyde from Hoechst Celanese Corporation, and about 10.2 grams of phenol (Bisphenol A from Dow Chemical Company). Into a 2000 ml glass vessel fitted with a stirrer, condenser, and thermocouple are placed about 300.5 grams of a 40.0% aqueous formaldehyde solution from Hoechst Celanese, about 168.6 grams of an 80.0% aqueous hydroxyoxapentylmelamine solution (HOM 154 from BASF AG), and about 2.0 grams of diethylethanolamine from Elf-Atochem North America, which are then mixed together and heated to about 60° C. The dry powder is then added to the liquid, and the reaction temperature is brought to about 95° C. The mixture is heated for approximately 186 minutes more and then cooled. Viscosity at this point is approximately 540 Pa sec. A small amount is extracted from the reaction mixture, is smeared between two glass plates and is hand drawn into fibers by pulling apart the plates. The fibers are cured in a continuous oven for about 16 hours at about 85° C., then for about 2 hours at about 120° C., and finally for about 1 hour at about 220° C. for additional strengthening. Titer and tensile properties are measured on 89 fibers after curing. Denier, tenacity and elongation (and their standard deviations in parentheses) are 2.6 g/9000 m (0.9 g/9000 m), 1.1 g/denier (0.6 g/denier) and 5.7% (2.7%), respectively.

### EXAMPLE 2

### Invention

A dry powder is formed by mixing together about 465.0 grams of melamine from Melamine Chemical, Inc., about 167.5 grams of paraformaldehyde from Hoechst Celanese Corporation, and about 10.2 grams of phenol (Bisphenol A from Dow Chemical Company). Into a 2000 ml glass vessel fitted with a stirrer, condenser, and thermocouple are placed about 196.8 grams of a 40.0% aqueous formaldehyde solution from Hoechst Celanese, about 168.6 grams of an 80.0% aqueous hydroxyoxapentylmelamine solution (HOM 154 from BASF AG), and about 2.0 grams of diethylethanolamine from Elf-Atochem North America, which are then mixed together and heated to about 80° C. The dry powder is then added to the liquid, and the reaction temperature is brought to about 95° C. After approximately 70 more minutes of heating at about 95°-100° C., about 214.6 grams of a 20.0% aqueous solution of the water-soluble polyamide of U.S. Pat. No. 3,846,507 (C-68 from BASF Corporation) is added. The mixture is heated for approximately 75 minutes more and then cooled. Viscosity at this point is approximately 540 Pa sec. Shortly before entry into the spinning apparatus, about 2 percent by weight, based on the mixture, of 35 percent strength by weight formic acid is homogeneously mixed in as an acidic catalyst. A small amount of the polymer composition, having a viscosity of approximately 145 Pa sec, is extracted from the reaction mixture. The polymer composition is smeared between two glass plates and is hand drawn into fibers by pulling apart the plates. The fibers are cured in a continuous oven for about 16 hours at about 85° C., then for about 1 hour at about 120° C., and finally for about 15 minutes at about 220° C. for additional strengthening. Titer and tensile properties are measured on 89 fibers after curing. Denier, tenacity and elongation (and their standard deviations in parentheses) are 2.7 g/9000 m (1.1 g/9000 m), 1.4 g/denier (0.8 g/denier) and 8.1% (4.1%), respectively.

### EXAMPLE 3

### Invention

The dry powder and liquid of Example 2 are formed, except that about 1.8 grams of diethylethanolamine is used in the liquid. The dry powder is then added to the liquid, and the reaction temperature is brought to about 95° C. After approximately 67 more minutes of heating at about 95°-100° C., about 143.0 grams of a 30.0% aqueous solution of the water-soluble copolymer of polyvinylpyrrolidone and vinyl acetate (Luviskol® from BASF AG) in the ratio 6:4 (VA-64) is added. The mixture is heated for approximately 90 minutes more and then cooled. Viscosity at this point is approximately 1100 Pa sec. Shortly before entry into the spinning apparatus, about 2 percent by weight, based on the mixture, of 35 percent strength by weight formic acid is homogeneously mixed in as an acidic catalyst. A small amount of the polymer composition, having a viscosity of approximately 300 Pa sec, is extracted from the reaction mixture and spun into fibers. The fibers are then collected and cured as in Example 2. Titer and tensile properties were measured on 100 fibers after curing. Denier, tenacity and elongation (and their standard deviations in parentheses) are 2.3 g/9000 m (1.0 g/9000 m), 1.7 g/denier (0.9 g/denier) and 7.9% (4.0%), respectively.

### EXAMPLE 4

### Invention

The dry powder and liquid mixture of Example 2 are formed. The dry powder is then added to the liquid, and the reaction temperature was brought to about 95° C. After approximately 75 more minutes of heating at about 95°-100° C., about 429.1 grams of a 10.0% aqueous solution of water-soluble polyvinyl alcohol polymer (available from Polysciences, Inc.) is added. The mixture is heated for approximately 70 more minutes and then cooled. Shortly before entry into the spinning apparatus, about 2 percent by weight, based on the mixture, of 35 percent strength by weight formic acid is homogeneously mixed in as an acidic catalyst. A small amount is extracted from the reaction mixture and spun into fibers. The fibers are then collected and cured as in Example 2. Titer and tensile properties are measured on 57 fibers after curing. Denier, tenacity and elongation (and their standard deviations in parentheses) are 3.7 g/9000 m (0.7 g/9000 m), 1.7 g/denier (0.6 g/denier) and 6.3% (1.9%) respectively.

### EXAMPLE 5

### Invention

The dry powder and liquid of Example 3 are formed. The dry powder is then added to the liquid, and the reaction temperature is brought to about 95° C. After approximately 65 more minutes of heating at about 95°-100° C., about 430 grams of a 6.0% aqueous solution of a water-soluble polyethylene oxide polymer (available from Polysciences, Inc) is added. The mixture is heated for approximately 96 minutes further and then cooled. Shortly before entry into the spinning apparatus, about 2 percent by weight, based on the mixture, of 35 percent strength by weight formic acid is homogeneously mixed in as an acidic catalyst. A small amount is extracted from the reaction mixture and spun into fibers. The fibers are then collected and cured as in Example 2. Titer and tensile properties are measured on 66 fibers after curing. Denier, tenacity and elongation (and their standard deviations in parentheses) are 3.7 g/9000 m (1.6 g/9000 m), 1.2 g/denier (0.6 g/denier) and 5.1% (1.9%), respectively.

### EXAMPLE 6

### Invention

The dry powder and liquid of Example 3 are formed. The dry powder is then added to the liquid, and the reaction temperature is brought to about 95° C. After approximately another 57 minutes of heating at about 95°-100° C., about 143.0 grams of a 30.0% aqueous solution of water-soluble polyvinylpyrrolidone (Kollidon® 90 F from BASF AG) is added. The mixture is heated for approximately 55 minutes more and then cooled. Viscosity at this point is approximately 658 Pa sec. Shortly before entry into the spinning apparatus, about 2 percent by weight, based on the mixture, of 35 percent strength by weight formic acid is homogeneously mixed in as an acidic catalyst. A small amount of polymer composition extracted from the reaction mixture is spun into fibers. The fibers are then collected and cured as in Example 2. Titer and tensile properties are measured on 51 fibers after curing. Denier, tenacity and elongation (and their standard deviations in parentheses) are 6.8 g/9000 m (2.6 g/9000 m), 0.6 g/denier (0.2 g/denier) and 3.1% (1.6%), respectively.

### EXAMPLE 7

### Invention

The dry powder and liquid of Example 3 are formed. The dry powder is then added to the liquid, and the reaction temperature is brought to about 95° C. After approximately another 67 minutes of heating at about 95°-100° C., about 143.0 grams of a 30.0% aqueous solution of a water-soluble polyester (Eastman AQ-35D, a 30% dispersion of LB-100 sulfonated polymer, from Eastman Chemical Company) is added. The mixture is heated for approximately another hour and then cooled. Viscosity at this point is approximately 1200 Pa sec. Shortly before entry into the spinning apparatus, about 2 percent by weight, based on the mixture, of 35 percent strength by weight formic acid is homogeneously mixed in as an acidic catalyst. A small amount is extracted from the reaction mixture and spun into fibers. The fibers are then collected and cured as in Example 1. Titer and tensile properties are measured on 94 fibers after curing. Denier, tenacity and elongation (and their standard deviations in parentheses) are 2.5 g/9000 m (0.8 g/9000 m), 0.9 g/denier (0.6 g/denier) and 3.7% (1.7%), respectively.

The examples indicate that it is possible to achieve a more thermoplastic character in fibers made from thermoset polymer by combining a solution of thermoplastic polymer with a solution of thermoset polymer into a single, fiber-forming polymer composition. Although certain physical properties of the fiber were measured, the significance of the measurements is limited because of the method of creating the fibers (i.e., hand drawing), the method of measuring the physical properties, the inherent variability in the physical properties of melamine-formaldehyde fiber, and the lack of rigorous condition-for-condition comparison.

While the invention has been described in connection with what is presently considered to be the most practical and preferred embodiment, it is to be understood that the invention is not to be limited to the disclosed embodiment, but on the contrary, is intended to cover various modifications and equivalents arrangements included within the spirit and scope of the appended claims.

What is claimed is:

1. A thermoset/thermoplastic fiber comprising a blend comprising:
(a) a thermoset polymer; and
(a) a thermoplastic polymer.

2. The fiber of claim 1, wherein the thermoset polymer is melamine.

3. The fiber of claim 2, wherein up to about 30 mole percent of the melamine is replaced by hydroxyalkylmelamine.

4. The fiber of claim 2, wherein the melamine is a condensation polymer of melamine, or melamine derivatives, with formaldehyde.

5. The fiber of claim 4, wherein up to about 30 mole percent of the melamine is replaced by hydroxyalkylmelamine.

6. The fiber of claim 4, wherein the condensation polymer is obtainable by condensation of a mixture comprising:
(a) from about 90 to about 99.9 mole percent of a mixture consisting essentially of:
(1) from about 30 to about 99 mole percent of melamine; and
(2) from about 1 to about 70 mole percent of a substituted melamine of the general formula I 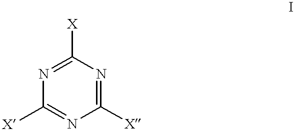
where X, X′ and X″ are each selected from the group consisting of —NH₂, —NHR, and —NRR′ and X, X′ and X″ are not all —NH₂, and R and R′ are each selected from the group consisting of hydroxy-C₂-C₁₀-alkyl, hydroxy-C₂-C₄-alkyl-(oxa-C₂-C₄-alkyl)ₙ, where n is a number from 1 to 5, and amino-C₂-C₁₂-alkyl, or mixtures of melamine I, and
(b) from about 0.1 to about 10 mole percent, based on (A) and (B), of phenols that are unsubstituted or that are substituted by radicals selected from the group consisting of C₁-C₉-alkyl and hydroxyl, C₁-C₄-alkanes substituted by two or three phenol groups, di(hydroxyphenyl) sulfones, or mixtures of these phenols,
with formaldehyde or formaldehyde-source compounds in a molar ratio of melamine to formaldehyde within the range of from about 1:1.15 to about 1:4.5, and, more preferably, from about 1:2.

7. The fiber of claim 1, wherein the thermoplastic polymer is selected from the group consisting of water-soluble thermoplastic polymers.

8. The fiber of claim 7, wherein the thermoplastic polymer is selected from the group consisting of polyamides with solubilizing substituents and copolymers thereof, polyesters with solubilizing substituents and copolymers thereof, polyolefins with solubilizing substituents and copolymers thereof, and cellulose polymers with solubilizing substituents and copolymers thereof.

9. The fiber of claim 8, wherein the thermoplastic polymer is selected from water-soluble polyamides, polyesters, and polyolefins and copolymers thereof.

10. A process for producing thermoset/thermoplastic fibers comprising the steps of:
(a) providing a suitable thermoset polymer;
(b) providing a suitable thermoplastic polymer;
(c) blending the thermoset polymer with the thermoplastic polymer to form a thermoset/thermoplastic polymer composition; and
(d) spinning thermoset/thermoplastic fibers from the polymer composition.

11. The process of claim 10, wherein the thermoset polymer resin is melamine.

12. The process of claim 11, wherein the melamine is a condensation polymer of melamine, or melamine derivatives, with formaldehyde.

13. The process of claim 11, wherein up to about 30 mole percent of the melamine is replaced by hydroxyalkylmelamine.

14. The process of claim 12, wherein up to about 30 mole percent of the melamine is replaced by hydroxyalkylmelamine.

15. The process of claim 12, wherein the condensation polymer is obtainable by condensation of a mixture comprising:
(a) from about 90 to about 99.9 mole percent of a mixture consisting essentially of:
(1) from about 30 to about 99 mole percent of melamine; and
(2) from about 1 to about 70 mole percent of a substituted melamine of the general formula I 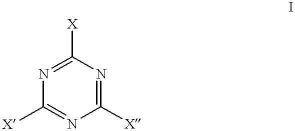
where X, X′ and X″ are each selected from the group consisting of —NH₂, —NHR, and —NRR′ and X, X′ and X″ are not all —NH₂, and R and R′ are each selected from the group consisting of hydroxy-C₂-C₁₀-alkyl, hydroxy-C₂-C₄-alkyl-(oxa-C₂-C₄-alkyl)ₙ, where n is a number from 1 to 5, and amino-C₂-C₁₂-alkyl, or mixtures of melamine I, and
(b) from about 0.1 to about 10 mole percent, based on (A) and (B), of phenols that are unsubstituted or that are substituted by radicals selected from the group consisting of C₁-C₉-alkyl and hydroxyl, C₁-C₄-alkanes substituted by two or three phenol groups, di(hydroxyphenyl) sulfones, or mixtures of these phenols,
with formaldehyde or formaldehyde-source compounds in a molar ratio of melamine to formaldehyde within the range of from about 1:1.15 to about 1:4.5, and, more preferably, from about 1:2.

16. The process of claim 10, wherein the thermoplastic polymer is selected from the group consisting of water-soluble thermoplastic polymers.

17. The process of claim 16, wherein the thermoplastic polymer is selected from the group consisting of polyamides with solubilizing substituents and copolymers thereof, polyesters with solubilizing substituents and copolymers thereof, polyolefins with solubilizing substituents and copolymers thereof, and cellulose polymers with solubilizing substituents and copolymers thereof.

18. The process of claim 17, wherein the thermoplastic polymer is selected from water-soluble polyamides, polyesters, and polyolefins and copolymers thereof.

19. The process of claim 10, wherein step (d) comprises a centrifugal spinning process.

20. The process of claim 19, wherein the centrifugal spinning process comprises supplying the thermoset/thermoplastic polymer composition to a whirler plate and ensuring that inside the whirler plate the resin is under a sufficient pressure to completely fill the nozzles of the whirler plate as the fibers are being spun.

21. The process of claim 10, further comprising the step of:
(e) subjecting the fibers to heat at temperatures ranging from about 180° C. to about 220° C. for a time sufficient to cure the fibers.
